(19) United States
(12) Patent Application Publication
(10) Pub. No.: US 2014/0249242 A1
(43) Pub. Date: Sep. 4, 2014

(54) GRAFTING OR CROSSLINKING OF UNSATURATED POLYOLEFINS BY BASE/ISOCYANATE INITIATION

(71) Applicants: Friedrich Georg Schmidt, Haltern am See (DE); Stefan Spange, Orlamuende (DE); Ingmar Polenz, Goettingen (DE)

(72) Inventors: Friedrich Georg Schmidt, Haltern am See (DE); Stefan Spange, Orlamuende (DE); Ingmar Polenz, Goettingen (DE)

(73) Assignee: Evonik Degussa GmbH, Essen (DE)

(21) Appl. No.: 14/343,591

(22) PCT Filed: Aug. 24, 2012
(86) PCT No.: PCT/EP12/66522

§ 371 Date: Mar. 7, 2014

(30) Foreign Application Priority Data
Sep. 13, 2011 (DE) 10 2011 112 963.8

(51) Int. Cl. C08F 279/02; C08L 77/00; C08L 67/00; C08L 69/00; C08L 47/00; C08F 136/06; C08L 75/04

(52) U.S. Cl. CPC C08F 279/02; C08F 136/06; C08L 77/00; C08L 75/04; C08L 69/00; C08L 47/00; C08L 67/00
USPC 521/137; 525/333.2; 525/242; 525/190; 525/126; 525/146; 521/140; 524/507; 524/534

(57) ABSTRACT

The present invention relates to a novel type of grafting or crosslinking method for (meth)acrylates in which the reaction is initiated by isocyanates and specific bases having an imine structure. Using this novel and specifically applicable method, polymers, particularly polyolefins having double bonds, may be grafted or crosslinked in a suitable reaction procedure.

Furthermore, these unsaturated polymers may be used, following reaction with (poly)isocyanates, to prepare graft or block copolymers or also for the bonding of the modified unsaturated polyolefins to polyamides, polyesters, polycarbonates, polyimines or polyurethanes.

### FIELD OF THE INVENTION

The present invention relates to a new type of grafting or crosslinking method for unsaturated polyolefins in which the reaction is initiated by isocyanates and specific bases having an imine structure. Using this new and specifically applicable method, polyolefins having double bonds, such as with methacrylate polymers, may be grafted or crosslinked in a suitable reaction procedure.

Furthermore, these unsaturated polyolefins may be used, following reaction with (poly)isocyanates, to prepare graft or block copolymers or else for the bonding of modified unsaturated polyolefins to polyamides, polyesters, polycarbonates, polyimines or polyurethanes.

### PRIOR ART

Both a mechanism for controlled crosslinking of polyolefins on demand and methods for preparing hybrid systems from a polyolefin and a second, preferably more polar, polymer have long been the goal of academic and industrial research.

Methods for the grafting of mostly amorphous polyolefins with acrylates and/or methacrylates have already been widely described. A method in the form of a free-radical solution polymerization can be found, for example, in DE 101 50 898. A conversion via a reactive extrusion is found in Badel et al. (J. of Pol. Sc.; Part A: Pol. Chem.; 45, 22, p. 5215, 2007). A variant of this method with an alternative initiation can be found in WO 2004 113 399. However, all of these methods have the major disadvantage that, firstly, only some of the polyolefin chains are grafted and, secondly, mainly poly(meth)acrylate homopolymers are formed.

A controlled graft reaction by way of halogen modification of a polyolefin and a subsequent atom transfer radical polymerization is found in Kaneko et al. (Macromol. Symp., 290, pp. 9-14, 2007). This method, however, has very many stages, is extremely complex and ineffective.

The initiation of an MMA polymerization with triethylamine and isocyanates is described in Okamoto et al (J. of Pol. Sci.: Polymer Chemistry, 12, 1974, pp. 1135-1140). The latter system, however, results only in yields below 20%.

WO 2011/085856 discloses a method for initiating the polymerization of (meth)acrylates with isocyanates and imines.

Both disclosures relate only to polymerizations of pure monomers such as (meth)acrylate monomers or mixtures thereof.

### PROBLEM

The object of the present invention is to provide a new method for the modification of polyolefins.

Firstly, the method should be suitable for functionalizing or grafting polyolefins, particularly for grafting with (meth)acrylates. In the latter case, the proportion of (meth)acrylate homopolymers in the product should be as low as possible.

Secondly, the method should be suitable for providing hybrid systems of polyolefins and other polymers such as polyamides, polyesters, polycarbonates, polyimines or polyurethanes.

Thirdly, the method should also be suitable for crosslinking polyolefins in a controlled manner and on demand.

It is a further object, moreover, to provide a method for solving the abovementioned problems, which can be used in a variable and versatile manner, and does not leave behind any troublesome (transition) metal-based initiator or catalyst residues.

Further objects not explicitly mentioned are apparent from the overall context of the description, claims and examples below.

### SOLUTION

The notation (meth)acrylate here means both methacrylate, for example, methyl methacrylate, ethyl methacrylate etc., and acrylate, for example, methyl acrylate, ethyl acrylate etc., and also mixtures of the two.

The objects have been achieved by a new method which has been found, very surprisingly, for modifying polyolefins.

This novel method is characterized in that the polyolefin has C—C double bonds and is admixed with two components A and B. Component A is a tertiary organic base, and component B is an isocyanate. Particularly good results are observed in this case if component B is an aromatic mono- or diisocyanate.

The polyolefin having C—C double bonds is, in particular, a polybutadiene, a polyisoprene, a metathesis (co)polymer, a styrene-butadiene copolymer, a styrene-butadiene block copolymer or an EPDM. The polyolefin is preferably a low or high molecular weight, optionally partially hydrogenated polybutadiene with 1,2- and/or 1,4-linkages, a polyisoprene, a polypentenamer, a polyoctenamer, a polynorbornene, a styrene-butadiene copolymer, a styrene-butadiene block copolymer or an EPDM.

There are three different preferred embodiments of the method according to the invention:

In the first embodiment component B is a monoisocyanate. After the addition of component A and B to the polyolefin, a vinylic monomer M is subsequently added. In this embodiment, side chains of the monomer M are formed on the polyolefin by a graft polymerization. The vinylic monomers M are, in this case, acrylates, methacrylates, styrene, monomers derived from styrene, α-olefins or mixtures of these monomers.

In this particular embodiment of the novel method, the grafting reaction with the monomers M is initiated by the presence of component A and component B. These components have reacted beforehand with the double bonds of the polyolefin such that an active initiating group has been formed on the polyolefin.

In the second preferred embodiment of the present invention, component B is a diisocyanate. Following addition of component A and B to the polyolefin, a polymer E is subsequently added to the mixture. This polymer has at least one OH or NH₂ group. In this method, the polyolefin is linked to the polymer E, for example, to a graft copolymer. If the polymer E has more than one of said groups, more highly branched or even crosslinked systems may also be formed.

Polymer E may be, in particular, a polyamide, a polyester, a polycarbonate, a polyimine or a polyurethane.

In the third preferred embodiment of the method according to the invention, component B is a di- or oligoisocyanate. By means of this polyvalent isocyanate, the polyolefin can then be crosslinked by supplying energy.

Component A is preferably a tertiary organic base, particularly preferably an organic base having a carbon-nitrogen double bond, or is alternatively a trithiocarbonate.

Bases having the following functional groups are particularly suitable for use in the initiation method according to the invention: imines, oxazolines, isoxazolones, thiazolines, amidines, guanidines, carbodiimides, imidazoles or trithiocarbonates.

Imines are understood to mean compounds having an (Rx)(Ry)C═N(Rz) group. Here, the two groups on the carbon atom Rx and Ry, and the single group on the nitrogen atom Rz, may be freely selected and are different or identical to each other, and it is also possible that these form one or more rings. Examples of such imines are 2-methylpyrroline (1), N-benzylidenemethylamine (BMA, (2)) or N-4-methoxybenzylideneaniline (3).

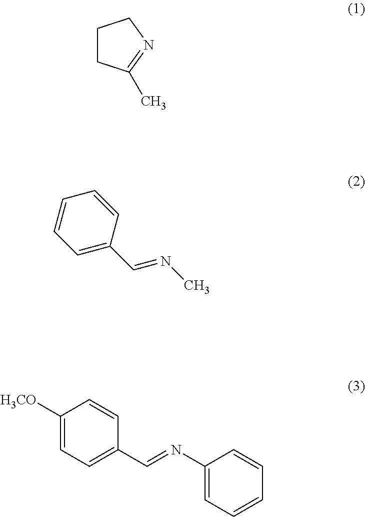

Oxazolines are compounds having an (Ry)O—C(Rx)=N(Rz) group. Also in these compounds, the groups on the carbon atom Rx, on the oxygen Ry and on the nitrogen atom Rz may in each case be freely selected, are different or identical to each other, and it is also possible that these form one or more rings. Examples of oxazolines are 2-ethyloxazoline (4) and 2-phenyloxazoline (5):

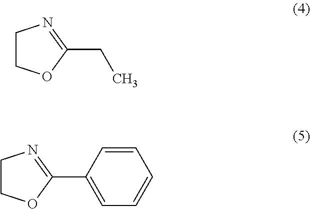

Isoxazolones are compounds having the structural element (6):

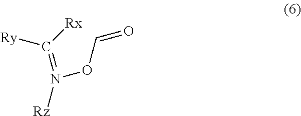

Also here, the two groups on the carbon atom Rx and Ry and the single group on the nitrogen atom Rz of the isoxazolones may be freely selected and may be different or identical to each other. It is also possible that these form one or more rings. An example of such an isoxazolone is 3-phenyl-5-isoxazolone (7):

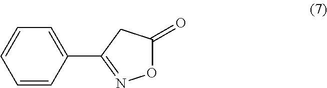 [SMILES: O=C1CC(c2ccccc2)=NO1]

Thiazolines are compounds having the structural element (8) or (9):

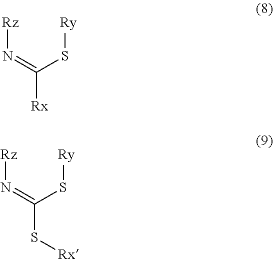

The groups on the carbon atom Rx, on the sulfur atom Ry, on the second sulfur atom Rx′ and on the nitrogen atom Rz may be freely selected and may be different or identical to each other. It is also possible that these form one or more rings. Examples of such thiazolines are 2-methylthiazoline (10) or 2-methylmercaptothiazoline (MMT, (11)):

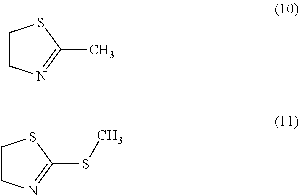

Amidines are compounds having the structural element (12) and guanidines are compounds having the structural element (13):

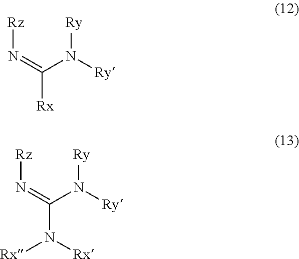

The groups on the carbon atom Rx, on the nitrogen atom Rz, on the second nitrogen atom Ry and Ry′ and on the third nitrogen atom Rx′ and Rx″ may be freely selected and may be different or identical to each other. It is also possible that these form one or more rings. Examples of amidines are 1,8-diazabicyclo[5.4.0]undec-7-ene (DBU, (14)), 1,5-diazabicyclo[4.3.0]non-5-ene (DBN, (15)) or N-(3-triethoxysilylpropyl)-4,5-dihydroimidazole (PDHI, (16)):

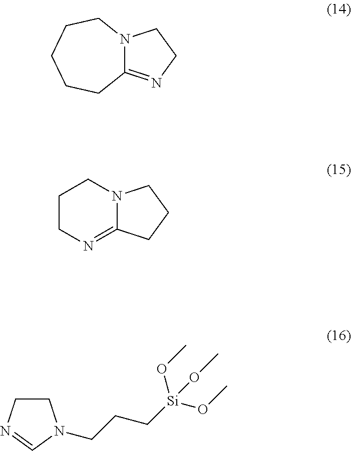

Examples of the guanidines are 7-methyl-1,5,7-triazabicyclo[4.4.0]dec-5-ene (MTBD, (17)), 1,1,3,3-tetramethylguanidine (TMG, (18)) or N-tert-butyl-1,1,3,3-tetramethylguanidine (19):

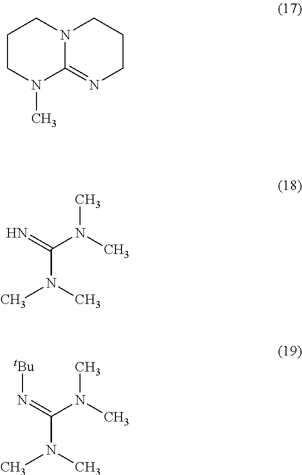

The group of the carbodiimides are compounds having the structural element (Rz)-N═C═N-(Rz′). The groups on the nitrogen atoms Rz and Rz′ may be freely selected and may be different or identical to each other. It is also possible that these form one or more rings. An example of a carbodiimide is diisopropylcarbodiimide (20):

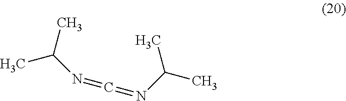

In addition, useful compounds may be imidazole (21) or 1-methylimidazole (22):

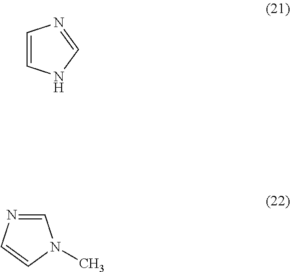

Examples of useful organic bases without C═N bonds include trithiocarbonates having the structural element (23):

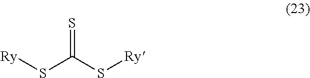

The groups on the two sulfur atoms Ry and Ry′ may be freely selected and may be different or identical to each other. It is also possible that these form one or more rings. An example of a trithiocarbonate is ethylidene trithiocarbonate (24):

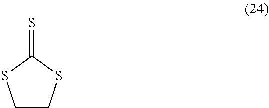

The examples of the organic bases are not suitable in any manner whatsoever for restricting the invention in any form. Instead, they serve to illustrate the variety of compounds which can be used according to the invention.

Component B is an isocyanate which may be mono- or polyfunctionalized. In particular, component B is an aliphatic or aromatic di- or polyisocyanate, or a monofunctional isocyanate, preferably phenyl isocyanate, cyclohexyl isocyanate, dodecyl isocyanate, ethyl isocyanate, butyl isocyanate, tert-butyl isocyanate or 4-(trifluoromethyl)phenyl isocyanate).

The term isocyanate furthermore also includes the chemically equivalent thioisocyanates.

The isocyanates may also have further functionalities. In one embodiment, these further functionalities may be other non-isocyanate functionalities which form stable compounds together with isocyanate groups.

Preferred examples of bifunctional isocyanates having two isocyanate groups are 1,6-hexamethylene diisocyanate (HDI, (25)), toluene diisocyanate (TDI, (26)) and isophorone diisocyanate (IPDI, (27)):

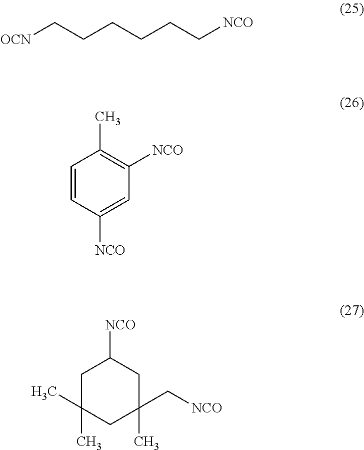

Similarly suitable examples are 2,2,3-trimethyl-1,6-hexamethylene diisocyanate (TMDI, (28)), bis(4-isocyanatocyclohexyl)methane (H₁₂MDI, (29)) or m-tetramethylxylylene diisocyanate (TMXDI, (30)):

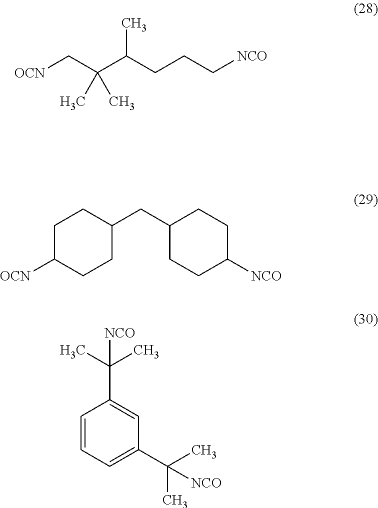

Examples of trifunctional isocyanates are condensates of these bifunctional isocyanates, particularly trimers of isocyanates having two isocyanate groups such as the HDI trimer (32) or the IPDI trimer (33):

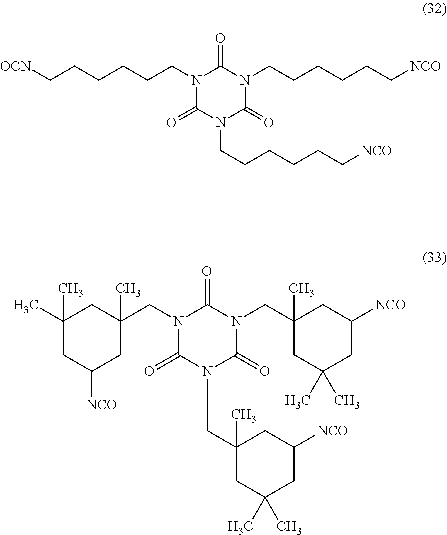

The method according to the invention for initiating a polymerization or for crosslinking is basically independent of the technique used. The method may be conducted, for example, in solution or as the pure substance.

The reaction may also be carried out across the entire customary temperature spectrum and at elevated, standard or reduced pressure.

In a particular embodiment of the present invention, additionally a component C, which is an ionic liquid, may be added to the mixture of polyolefin, component A and component B. By adding this component C, the reactivity is additionally increased and the reaction either proceeds more rapidly or may be carried out at lower temperatures at a comparable rate. In this case, particular preference is given to a method in which the modification of the polyolefin is conducted at a temperature below 50° C.

Specifically, the cation of the ionic liquid is an imidazolium, a pyridinium, a pyrrolidinium, a guanidinium, a uronium, a thiouronium, a piperidinium, a morpholinium, an ammonium or a phosphonium.

The anion is then correspondingly a halide, a nitrate, a carboxylate, a borate, preferably tetrafluoroborate or tetraphenylborate, a trifluoroacetate, a triflate, a phosphate, preferably hexafluorophosphate or tris(perfluoroethyl)trifluorophosphate, a phosphinate, a tosylate, an imide, preferably bis(trifluoromethylsulfonyl)imide or an amide.

The polymers or crosslinked systems prepared according to the novel method can be used in many application fields.

The modified, thermoplastic polyolefins described, which have been grafted either with the monomers M or with the polymers E, may preferably be used as an additive, primer, compatibilizer, coating material or in adhesives or sealants.

The crosslinked polyolefins described, which have been reacted either a conetwork with the polymer E or directly to form a homonetwork, may preferably be used as duroplasts, as thermosets, as a rubber, as impact modifiers, as an additive in TPO or TPU materials, as foam bodies, as an additive to foam bodies, as a sealing material or as a damping material.

### EXAMPLES

The weight average molecular weights of the polymers from examples 1 to 4 were determined by means of GPC (gel permeation chromatography). The measurements were carried out using a PL-GPC 50 Plus from Polymer Laboratories Inc. at 40° C. and a flow rate of 1.0 mL/min in THF relative to a polystyrene standard.

The determination of the yields was carried out by weighing the isolated polymer after drying to constant weight in a vacuum drying cabinet at 60° C. and 20 mbar.

The polybutadiene used refers to Polyoil 110 from Evonik Degussa GmbH having molar weights of 2900 g/mol (Mₑ) and 6700 g/mol (M_{w}) and a PDI of 2.34. For better comparability with the experimental results, a Polyoil 110 sample was washed with methanol. The residual polybutadiene had molar weights of 3600 g/mol (Mₑ) and 7400 g/mol (M_{w}) and a PDI of 2.04.

General Procedure for the Examples

2 g of polybutadiene were weighed into a 25 mL round-bottomed flask and 2 mL of dry THF, 1.86 mmol of MMT (2-methylmercaptothiazoline (11); 0.248 g) and the equivalent amount of a diisocyanate (exact description and amount: see below) were added. The reaction mixture is heated to 60° C. in an argon atmosphere under a reflux condenser with bubble counter. After 22 h, approximately half of the solution is removed and cooled and slowly precipitated in 80 mL of methanol. The residue obtained is washed five times with methanol. The remaining reaction solution is similarly processed after 46 h. For other batches, a reaction time of 94 h was selected. For comparison, 2 g of a pure polybutadiene were dissolved in 2 mL of dry THF, which was precipitated in 80 mL of methanol and was washed five times each with 80 ml of methanol. There were two further comparative examples which were conducted analogously to the standard procedure. In this case, the workup was also carried out according to the method described above.

In each case a mixture of soluble and insoluble fractions was obtained as products. The insoluble fractions were swellable and insoluble. From this it can be concluded that the crosslinking reaction took place. The resultant soluble fractions of the modified polybutadienes were initially analyzed by GPC in order to assess the degree of crosslinking. An increase in the PDI, and also the number and weight average, indicates an increasing interpolymeric reaction of the polybutadiene.

### Example 1

0.313 g of HDI (25) was used as isocyanate. Relatively large amounts of an insoluble product could be detected after 22, 46 and 94 hours.

### Example 2

0.413 g of IPDI (27) was used as isocyanate. Relatively large amounts of an insoluble product could be detected after 22, 46 and 94 hours.

### Example 3

0.488 g of H₁₂MDI (29) was used as isocyanate. Relatively large amounts of an insoluble product could be detected after 22, 46 and 94 hours.

### Example 4

0.380 g of TMDI (28) was used as isocyanate. Relatively large amounts of an insoluble product could be detected after 22, 46 and 94 hours.

### Comparative Example 1

Experiment without diisocyanate and without MMT No insoluble product could be detected after 22 or 46 hours. After 94 hours only minor amounts could be detected.

### Comparative Example 2

Experiment without diisocyanate and with MMT. No insoluble product could be detected after 22 or 46 hours. After 94 hours, minor amounts of insoluble product were formed.

TABLE 1
Results of the GPC analysis of the soluble fraction of the crosslinked polybutadienes.

| | Sample after 22 h | | | Sample after 46 h | | |
|---|---|---|---|---|---|---|
| Example | PDI | Mₙ [g/mol] | M_{w} [g/mol] | PDI | Mₙ [g/mol] | M_{w} [g/mol] |
| PB + ΔT | 1.99 | 3900 | 7800 | 2.01 | 4200 | 8400 |
| with only MMT | 2.17 | 4000 | 8700 | 2.50 | 4200 | 10 600 |
| Example 1 | 2.07 | 3700 | 7700 | 2.36 | 3900 | 9300 |
| Example 2 | 2.12 | 3600 | 7700 | 2.40 | 4300 | 10 300 |
| Example 3 | 2.05 | 3900 | 7900 | 2.49 | 4300 | 10 700 |
| Example 4 | 2.51 | 4100 | 10 400 | 2.88 | 4500 | 12 800 |

| | Sample after 94 h | | |
|---|---|---|---|
| | PDI | Mₙ [g/mol] | M_{w} [g/mol] |
| PB + ΔT | 2.53 | 4400 | 11 100 |
| with only MMT | 2.21 | 4000 | 8800 |
| Example 1 | 3.32 | 4200 | 14 000 |
| Example 2 | 3.39 | 4500 | 15 200 |
| Example 3 | 3.63 | 5200 | 19 000 |
| Example 4 | 3.46 | 4400 | 15 200 |

PDI: Polydispersity index (=M_{w}/Mₙ)

1. A method for modifying a polyolefin, the method comprising
contacting a component A and a component B with a polyolefin comprising a C—C double bond,
wherein component A is a tertiary organic base, and component B is an isocyanate.

2. The method of claim 1, wherein component A is a trithiocarbonate, an imine, an oxazoline, a thiazoline, an amidine, a guanidine, an imidazole, a carbodiimide or an isoxazolone.

3. The method of claim 1, wherein component B is cyclohexyl isocyanate, ethyl isocyanate, butyl isocyanate, tert-butyl isocyanate, phenyl isocyanate, dodecyl isocyanate, 4-(trifluoromethyl)phenyl isocyanate), 1,6-hexamethylene diisocyanate (HDI), an HDI trimer, toluene diisocyanate (TDI), isophorone diisocyanate (IPDI) or an IPDI trimer.

4. The method of claim 1, wherein the polyolefin is a polybutadiene, a polyisoprene, a metathesis (co)polymer, a styrene-butadiene copolymer, a styrene-butadiene block copolymer or an EPDM.

5. The method of claim 1, wherein component B is a monoisocyanate, and the method further comprises adding a vinylic monomer M to obtain side chains formed on the polyolefin.

6. The method of claim 1, wherein component B is a diisocyanate, and the method further comprises adding a polymer E that has at least one OH or NH₂ group, such that the polyolefin is linked to the polymer E.

7. The method of claim 1, wherein component B is a di- or oligoisocyanate, and the polyolefin is crosslinked by supplying energy.

8. The method of claim 5, wherein the vinylic monomer M is at least one monomer selected from the group consisting of a methacrylate, styrene, a monomer derived from styrene, and an α-olefin.

9. The method of claim 6, wherein the polymer E is a polyamide, polyester, polycarbonate, polyimine or polyurethane.

10. The method of claim 4, wherein the polyolefin is a low or high molecular weight, optionally partially hydrogenated polybutadiene with 1,2- and/or 1,4-linkages, a polyisoprene, a polypentenamer, a polyoctenamer, a polynorbornene, a styrene-butadiene copolymer, a styrene-butadiene block copolymer or an EPDM.

11. The method of claim 1, wherein component B is an aromatic mono- or diisocyanate.

12. The method of claim 1, further comprising adding a component C, which is an ionic liquid comprising a cation and an anion, to the mixture of polyolefin, component A and component B.

13. The method of claim 12, wherein:
the modification of the polyolefin is conducted at a temperature below 50° C.,
the cation is an imidazolium, a pyridinium, a pyrrolidinium, a guanidinium, a uronium, a thioronium, a piperidinium, a morpholinium, an ammonium or a phosphonium, and
the anion is a halide, a nitrate, a carboxylate, a borate, a trifluoroacetate, a triflate, a phosphate, a phosphinate, a tosylate, an imide, or an amide.

14. A duroplast, a thermoset, a rubber, an impact modifier, an additive in TPO or TPU materials, a foam body, an additive to foam bodies, a sealing material or a damping material comprising a crosslinked polyolefin obtained by the method of claim 6.

15. An additive, primer, compatibilizer, coating material, adhesive or sealant comprising a modified polyolefin obtained by the method of claim 5.
